(19) United States
(12) Patent Application Publication
(10) Pub. No.: US 2006/0113030 A1
(43) Pub. Date: Jun. 1, 2006

(54) Apparatus and method for heat sealing a lidding sheet

(76) Inventors: Peter John Houzego, Cambridge (GB); David Nightingale, Cambridge (GB)

Correspondence Address: FOLEY AND LARDNER LLP;SUITE 500, 3000 K STREET NW, WASHINGTON, DC, 20007, US

(21) Appl. No.: 10/544,232

(22) PCT Filed: Feb. 5, 2004
(86) PCT No.: PCT/GB04/00417

§ 371 Date: Dec. 29, 2005

(30) Foreign Application Priority Data
Feb. 6, 2003 (GB) 0302780.2

(51) Int. Cl. B29C 65/02; B32B 37/00

(52) U.S. Cl. 156/285; 156/580; 156/311

(57) ABSTRACT

An apparatus and method for heat sealing a lidding sheet to a base, wherein the apparatus including a press for pressing a lidding sheet onto a sealing surface of a base, the press including a relatively flexible face plate and the apparatus further including a system for applying pressure to the lidding sheet with the face plate, the face plate flexing to conform to the lidding sheet and the underlying profile of the sealing surface of the base.

The present invention relates to an apparatus and method for heat sealing a lidding sheet to a base, in particular where the lidding sheet is required to be pressed against the base during heat sealing.

The regulations governing the packaging of pharmaceutical products impose severe restrictions on the materials that can be used in the packaging. Any material that can have contact with the pharmaceutical product must have a traceable manufacturing route that guarantees that there will not be any chemicals within the packaging material that could transfer into the pharmaceutical product and so enter the patient's body.

This limits the use of conventional adhesives whose formulations frequently contain a proportion of volatile actives. It encourages the use of heat-sealing technology where the seal is formed by melting a substantially pure single component material to fill the interface in order to form the seal.

Where the packaging itself can be made of a material that melts at a suitable temperature then applying heat and pressure at the interface to be sealed is sufficient to seal the package closed. Where the packaging material is made with a material that does not melt at a sufficient low temperature then additional layers of a suitable material need to be introduced at the sealing interface. This is the case where the packaging is required to provide high levels of protection against the penetration of gases such as oxygen, carbon dioxide or water vapour. Materials suitable for heat sealing all have some degree of permeability to gases. Hence, for these applications it may be necessary to use polymers with high melting points or even metals to achieve sufficient barrier properties.

A good example of this is the use of aluminium laminate foils for the unit dose packaging of some pharmaceutical products. The aluminium layer, typically in the range 0.01 mm to 0.10 mm thickness, provides, where pin-hole free, an excellent barrier to all gases. The metal layer is laminated with various polymer layers to add functionality such as, ductility and ink receptive or heat sealable surfaces. A common format is the blister pack where one sheet of laminate has an array of pockets formed in it and a flat lidding sheet is bonded against the surface containing the open sides of the pockets to seal each pocket as a separate package.

The sealing process can be achieved either by pressing the surfaces together with a hot roller or by using a heated platen press. Where the platen approach is used the areas over which the sealing is required are compressed between two hot flat surfaces until the sealing layers fuse together; The pressure and heat are then removed, and the cooling of the joint hardens the seal making the joint permanent.

For most applications this approach is sufficient. However, in order to achieve a good seal, it is important that the sealing materials fuse together over all of the sealing area. Where only partial sealing occurs then thin gaps may exist between the layers sufficient for gases to diffuse through and damage the contents of the package. As the laminate materials are typically less than 0.1 mm thick then any variation in the, gap between the rigid platen plates at different parts of the surface could cause a large change in the pressure at different points. In the extreme, this could lead to some areas having zero pressure and a bond not being made at this area.

Thicker polymer material could be included such that the material flows within the seal during sealing, thereby filling any small irregularities caused by out of plane bumps or hollows within the platens or the package material. However, for the highest integrity packaging requirements, increasing the thickness of the polymer layers which seal between the impermeable layers introduces the problem of higher diffusion of the gas through the sealing material along the plane of the seal.

It is preferred to have the thinnest possible sealing layer between the impermeable layers.

Using conventional platen or rolling heat-sealing equipment, the quality of the seal has been such that, in order to ensure a reliable seal, it is necessary to allow as large a sealing area around the package as possible. For tablets and capsules then seal lengths of 5 mm to 10 mm can be used without increasing the size of the packaging unacceptably.

However, a more recent requirement for unit dose packaging has been for Dry Powder Inhalers (DPI's) where the mass of the unit dose is very small, 10 mg for example. In this case, small portable dispensers for multiple doses, may be required. Some DPI's store the medicament in a bulk reservoir. However, protecting the bulk reservoir from water vapour ingress in a way that still allows accurate metering out of the unit doses is difficult. To overcome this, DPI's have been developed that provide pre-metered unit doses of drug in separate packages, a plurality of which are loaded into the DPI. For these DPI's, reducing the area of the seal to a minimum becomes critical in order to achieve an acceptable overall package size. In addition, the drug product in a DPI is in a fine powder form which is extremely sensitive to any water vapour that penetrates the packaging. The ability to accurately control the sealing pressure and temperature at all points over the sealing area is therefore of major importance.

It is thus an object of the present invention to provide an improved apparatus and method for heat sealing.

According to the present invention, there is provided a method of heat sealing a lidding sheet to a base, the method including:

positioning a lidding sheet against the sealing surface of a base;

providing a relatively flexible face plate adjacent the lidding sheet; and

applying pressure to the lidding sheet with the face plate such that the face plate flexes to conform to the lidding sheet and the underlying profile of the sealing surface of the base.

According to the present invention, there is also provided an apparatus for heat sealing a lidding sheet to a base, the apparatus including:

a platen press for pressing a lidding sheet onto a sealing surface of a base; wherein

the platen press includes a relatively flexible face plate and the apparatus further includes a system for applying pressure to the lidding sheet with the face plate, the face plate flexing to conform to the lidding sheet and the underlying profile of the sealing surface of the base.

In this way, the lidding sheet can be held closely against the sealing surface of the base even if the sealing surface of the base is not entirely planar. It becomes possible to apply uniform and controlled pressure over the whole of the sealing area without requiring any deformation of the packaging material. It therefore also facilitates the use of very thin heat seal layers which in turn have the advantage of reducing moisture migration.

The face plate isolates the lidding sheet and base from the rest of the press such that a variety of heating and pressing techniques and materials may be used whilst remaining within regulations for cleanliness and material contamination. With a face plate formed as a self supporting member, it is possible to use any appropriate means for providing a pressure on its back surface.

Hence, the invention provides a way of platen heat sealing that offers substantial benefits for the formation of high performance water vapour barrier seals in pharmaceutical packages. It allows uniform pressure to be applied across all parts of the surfaces to be sealed whilst the temperature of the sealing interface is rapidly heated to the required sealing temperature and then cooled to below the temperature at which the sealing layers harden.

Preferably, a support plate is provided for supporting a back surface of the base opposite the sealing surface.

In this way, additional support may be given to the base so as to allow increased pressure from the face plate. This may be particularly advantageous where the base takes the form of a blister pack package having a generally planar top layer with one or more pockets extending below the top layer. In this case, the base may be provided to support the top layer from below at positions around and between pockets.

Preferably, the face plate comprises a flexible membrane with a first surface for pressing the lidding sheet, the system being arranged to selectively provide pressurised fluid to a second surface of the flexible membrane, the second surface being opposite the first surface.

Hence, the pressurised fluid may flex the flexible membrane and apply pressure to the lidding sheet.

This is a particularly effective way of ensuring that uniform pressure is applied across all surfaces to be sealed.

Preferably, the fluid is pressurised in the range of 2 bar to 200 bar.

The actual pressure may be determined according to the material properties and thickness of the flexible membrane. The actual pressure may also be chosen according to the properties of the lidding sheet, the heat sealing material and the surface profile of the base package.

Preferably, the platen press further includes walls which define with the second surface a chamber for receiving the pressurised fluid.

In this way, the flexible membrane itself is directly flexed by the fluid. It would be possible to provide indirect pressure, for instance using a flexible sealed chamber behind the flexible membrane. However, better performance can be achieved with the flexible membrane itself forming part of the chamber.

Preferably, the pressurised fluid is provided at an elevated temperature suitable for achieving heat sealing.

Although separate heaters, such as infra red heaters, could be used, the direct contact of the flexible membrane with the lidding sheet and the proximity of the pressurised fluid makes the use of the fluid for heating the sealing interface particularly effective.

Preferably, the face plate is rapidly heated and then cooled whilst maintaining pressure to the lidding sheet.

By rapidly heating and cooling the face plate in this way, it is possible to achieve good heat sealing without unduly heating any material contained in a pack formed by the lidding sheet and base. This is particularly advantageous with certain pharmaceutical products or medicaments which are sensitive to temperature.

Where the pressurised fluid is used to heat the sealing interface, it is possible to rapidly exchange the pressurised fluid from hot fluid to cold fluid so as to rapidly heat and then cool the face plate whilst maintaining pressure to the lidding sheet.

In this respect, the chamber may be provided with at least one inlet and at least one outlet such that fluid may be pumped in through the inlet and out through the outlet.

The system may be arranged to pump hot fluid in the inlet so as to heat the flexible membrane and lidding sheet for sealing and then to pump cold fluid in the inlet so as to force the hot fluid out through the outlet and thereby cool the flexible membrane and lidding sheet.

In this way, the sealing interface may easily and effectively be rapidly heated and then cooled so as to form the required seal without unduly heating the rest of the base package and any contained material.

Since the pressurised fluid is required to be in close proximity to the lidding sheet by virtue of using a relatively thin and flexible face plate, controlling the temperature of the sealing interface with the same fluid is particularly effective and advantageous.

Preferably, the system provides hot fluid in the range of 75° C. to 300° C.

Preferably, the system provides cold fluid in the range 0° C. to 30° C.

The exact choice of temperature will vary according to the material properties of the sealing layer and also the thermal conductivity and specific heat capacity of components such as the flexible face plate, lidding sheet and base. The temperatures will also depend on how critical it is that the sealed lidding sheet/base arrangement not be at an elevated temperature. In some applications, it may be acceptable to have the arrangement at a high temperature for some considerable time.

Preferably, the face plate is stainless steel.

This material is highly advantageous with regard to cleanliness and is corrosion resistant. It also has good elastic properties such that with appropriate pressure, it will elastically deform to conform to the profile of the sealing interface providing that the amount of deformation required is less than 0.5% and will subsequently return to its original state ready for use again.

Preferably, the face plate has a thickness in the range of 0.01 mm to 0.5 mm. More preferably, the thickness is in the range of 0.03 mm to 0.1 mm.

With these thicknesses, the plate is able to deform elastically as required and also to conduct heat effectively.

The actual thickness chosen will depend on the material properties of the face plate and the extent to which it is required to deform elasticallly.

Where the sealing surface has surface contours requiring the face to deform by such an amount that the strain in the face plate exceeds 0.5% then it might not be possible to use stainless steel because the surface would not return to its original form when the pressure was removed.

However, in these circumstances, other materials may be used, although they are not as preferred from a materials compatibility aspect.

For surfaces requiring strains in the range 0.3% to 1.0% then an alloy such as beryllium copper could be employed or an amorphous metal material such as those marketed under the name of liquid metal alloys or superplastic or shape memory metals such as Nitinol.

Preferably, where a lidding sheet is to be sealed to a base having at least one pocket, the face plate is reinforced in an area to be positioned opposite the at least one pocket so as to at least reduce deflection of the face plate into the pocket.

This allows additional and more effective pressure to be exerted on the sealing areas around the pockets without risking any damage to the area of the lidding sheet which crosses the pocket itself.

Preferably, the face plate is reinforced by preforming the area as a dome, recessed on the sealing side.

In this way, the face plate does not exert pressure on the lidding sheet in the areas where it crosses a pocket. The face plate could be reinforced by thickening the appropriate areas. However, the use of a dome shape does not require additional material and is more simple to manufacture.

Preferably the apparatus is arranged to compensate for angular misalignment of the face plate and the sealing surface of the base. It may be that the sealing surface of the base is generally skew or at an angle to the apparatus, for instance, because its opposite back surface is not parallel. It is possible to provide a flexible face plate which is sufficiently flexible so as to compensate for any such misalignment. However, so as to minimise the extent to which the flexible face plate must elastically deform, it is preferable that one or both of the press and the platen are free to move such that the sealing surface of the base and the flexible face plate self-align.

Thus, there may be provided an arrangement for applying uniform pressure across all parts of the surfaces to be sealed together without applying any pressure to areas not to be sealed whilst the temperature of the sealing interface is rapidly raised to the required sealing temperature and then cooled to below the temperature at which the sealing layers harden.

The invention will be more clearly understood from the following description, given by way of example only, with reference to the accompanying drawings, in which:

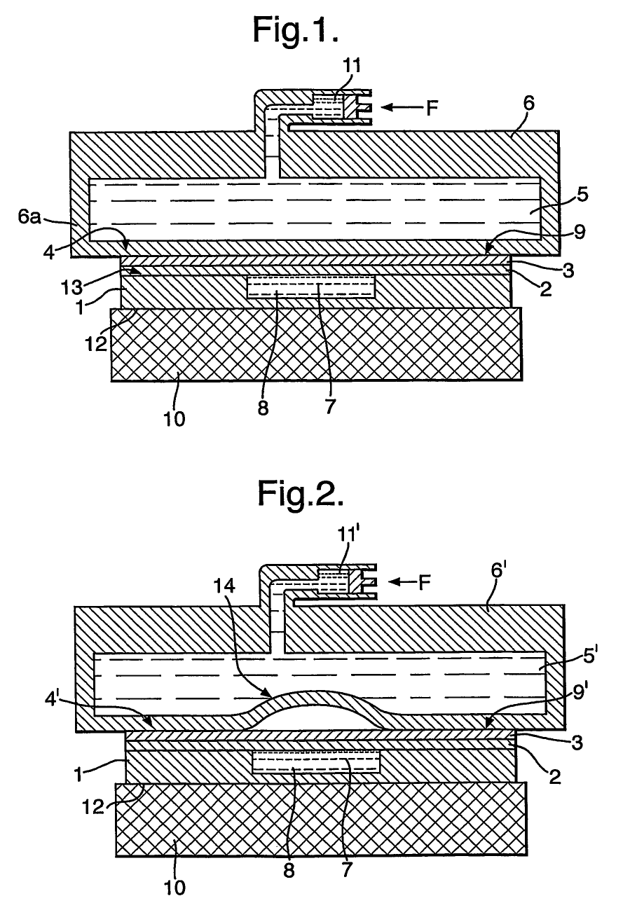

FIG. 1 illustrates an embodiment of the present invention;

FIG. 2 illustrates another embodiment of the present invention;

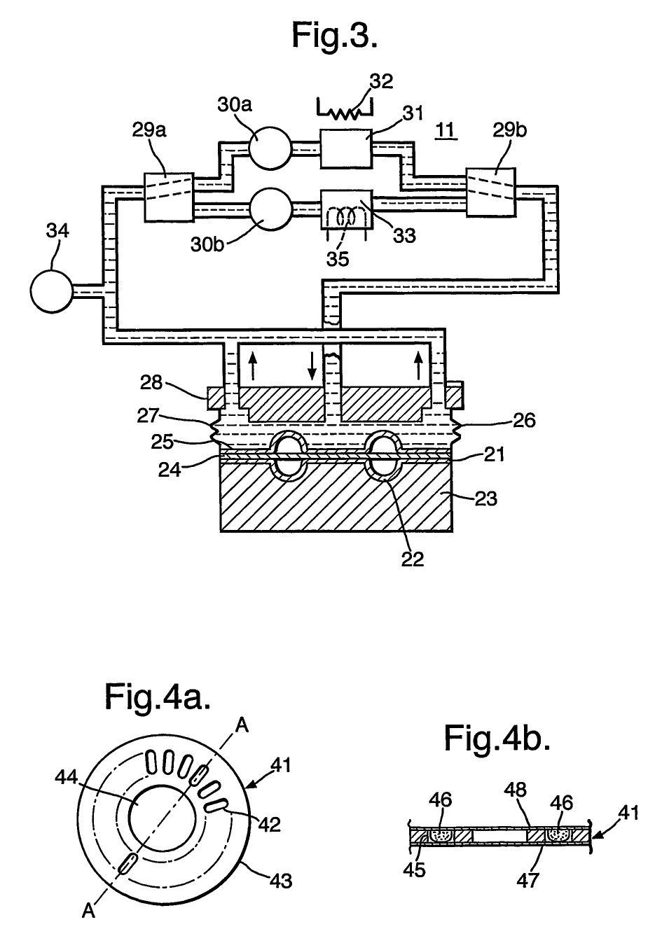

FIG. 3 illustrates another embodiment of the present invention;

FIGS. 4(a) and (b) illustrate a pack for which the present invention is particularly useful in sealing the lidding sheet to the base;

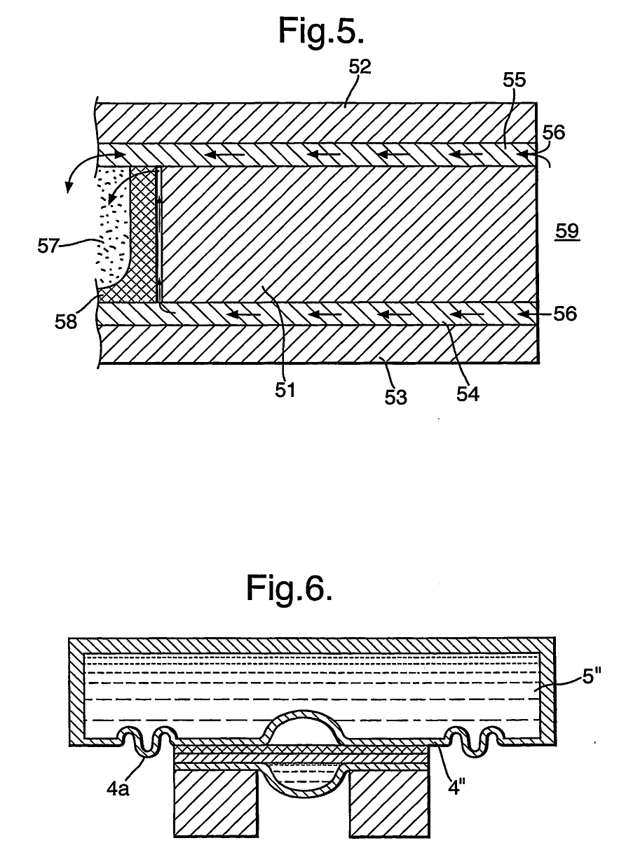

FIG. 5 illustrates a partial cross-section though the pack of FIGS. 4(a) and (b); and

FIG. 6 illustrates another embodiment of the present invention.

In preferred embodiments, the invention uses a thin sheet of stainless steel to conduct heat and pressure from a temperature controlled pressurised fluid on one side of the sheet to the top surface of a lidding material on the other side of the sheet so as to heat seal the lidding material to a package base. This is illustrated in FIG. 1 which shows a package base 1 into which a pocket 8 has been formed suitable for containing a unit dose 7 of a medicament. The open area of the pocket 8 is to be sealed with a lidding sheet comprising a layer of impermeable material 3 such as aluminium and a heat-sealing layer 2. In order to heat seal the lid 3 to the package 1, a platen press 6 that has a stainless steel face plate 4 separated from it by a layer of a fluid 5. The press includes walls 6a, which together with the face plate 4 form a chamber for the fluid 5. The press is lowered so that the face plate 4 is in contact with the outer surface 9 of the lidding foil 3. If the fluid 5 is then pressurised by the pump 11, with the platen press 6 and package base 1 being held stationary, the face plate 4 is pressed against the top surface 9 of the lidding foil 3, the package base 1 being held firmly in place by the lower support plate 10 on the back surface 12 of the package base 1.

If the surface 13 to be sealed is perfectly flat then uniform pressure is exerted over the whole of that surface. Where the surface 13 is not flat and of sufficient rigidity that it will not deform under the applied pressure, then in order for a uniform pressure to be exerted on the surface, the face plate 4 must deform to follow the contours of the surface 13. It is therefore necessary to choose the thickness of the face plate 4 and the pressure in the fluid such that the face plate 4 can deform to lie against the worst possible surface irregularities of the top surface 13 and lidding foil 3. In addition, to allow for repeated re-use of the face plate 4 it is preferable that any deformation should be achieved by elastic deformation of the face plate 4.

To achieve these requirements, the face plate material should preferably be formed from sheet material with a thickness in the range 0.01 mm to 0.1 mm.

Typically, pressures in the range of 2 bar to 200 bar are preferred with the higher pressure being used with thicker face plate material.

As an example, take the case where the surface 13 is nominally flat but has shallow hollows over some places on the surface. The most difficult type of hollow for the face plate 4 to deform into would be the one with the highest depth to diameter ratio. To estimate the thickness of the face plate 4 and the appropriate pressure analytically we can analyse the face plate 4 as a thin plate clamped around the edge of the hollow.

An approximate estimate of the relationship between the parameters can be obtained using the formula:

$$h = \frac{{Pr}^{4}}{kD}$$

h=depth of deflection at the centre of the hollow (m)
P=fluid pressure (Pa)
r=radius of the hollow (m)
k=edge constraint constant
D=flexural stiffness of the face plate (Nm)

The value of k depends upon whether the edges are simply supported (k=12) or fully clamped (k=64).

Taking the example of a 50 micron thick stainless steel face plate 4 simply supported at 1 mm radius then applying 10 bar pressure deflects the face plate 4 to follow a hollow up to 100 microns deep. In practice, the edges of any hollows will be somewhere in between simply supported and fully clamped.

However, with the arrangement of FIG. 1, the face plate 4 will bend inwards over the pockets area as the pressure is applied. It would be possible to make the face plate 4 sufficiently thick so that the deformations are not sufficient to rupture the lidding foil 3. However, this would reduce its ability to follow surface height variations on the sealing areas. It is therefore preferred that the face plate 4 has the areas above the pockets reinforced to prevent then deflecting into the pocket. This is possible as there is no requirement to form a seal over this area. Methods that can be used to achieve this include:
Thickening the face plate material over the pockets
Forming concave domed recesses in the face plate over the pockets

FIG. 2 shows an example in which the face plate 4′ has been domed 14 over the pocket 8. The general arrangement is the same as for FIG. 1. However, the face plate 4′ in the region over the pocket 8 has been plastically deformed to form a dome 14. A dome has much greater rigidity against isostatic forces over its surface and therefore, when the fluid above it is pressurised, it will maintain its shape.

Where this approach is used, it is necessary to keep the pressure below that value at which the dome 14 would buckle and snap through into a convex form. This can be calculated using the theory on the stability of thin walled shell structures but is preferably determined experimentally.

Both approaches have the added advantage that they will boost the pressure around the edge of the pocket compared to the rest of the surface. For the case where the face plate 4 has been made thicker over the pocket so that it remains substantially flat even when the pressure is applied if the reinforced area overlaps onto the surface for a distance, then the pressure over this area compared to the applied, pressure is given by:

$$\frac{{P}_{edge}}{{P}_{fluid}} = 1 + \frac{A}{wl}$$

P_{edge}=Pressure exerted around the pocket periphery (Pa)
P_{fluid}=Fluid pressure (Pa)
A=pocket area (m²)
I=pocket perimeter (m)
w=overlap length (m)

This helps to ensure that a good seal is formed around each pocket.

These arrangements enable the face plate to apply uniform pressure onto a surface with small amounts of undulations on its surface.

The plane of the surface to be sealed may not be perfectly parallel to the plane of the face plate 4. Preferably, therefore means are provided to allow any angular misalignment to be accommodated so that the face plate 4 is only required to stretch to respond to waviness of the surface.

Various methods can be used to achieve this:
Supporting the face plate on bellows
Active control of the angle of one surface in response to measurement of the angular misalignment
Introducing a compliant member behind the platen
Fabricating a compliant support form into the face plate that allows the flat active area to tilt, up to a defined angle, in any direction. An example of such a form is a bellows 4a or convoluted annular portion of the plate around the active area (see FIG. 6).

The approach described above provides a means of achieving accurate uniform pressure over a practical heat-sealing surface. However, it is still necessary to heat the sealing interface to melt it sufficiently for the bond to form.

This can be achieved by using a press that is maintained at a higher temperature than that necessary to form the seal. Heat flows from the press into the packaging material when the press is forced against the top surface of the lid.

After sufficient time for the interface to reach the desired temperature the press is removed and the package cooled by natural convection to the air or by conduction to a second cold platen.

This process can potentially lead to imperfect sealing as the pressure is removed whilst the interface is still softened by heat. In addition, where the package has significant thermal mass and high thermal conductivity, some of the heat may reach medicament in a pocket with the possibility of degrading it. A preferred approach would be for the interface region to be actively heated and then cooled as rapidly as possible whilst constant pressure is applied.

In this way, minimal heat challenge is given to the medicament and the heat seal is cold and firm before pressure is removed.

The arrangement of a thin face plate backed by a pressurised fluid is ideally suited to achieve this rapid heating and cooling under pressure.

One arrangement for heating and cooling the faceplate is for the back plate 6 to be in good thermal contact with heating and cooling means.

In this way, an electrical heater located on back plate 6 may be used to control the temperature which is advantageous as this provides a simple means for precise temperature control. Similarly, to cool the face plate, water channels may be located in the back plate 6 through which cold water can flow when cooling is required.

Where such an approach is used it is important that the thermal conductivity of the pressurising fluid is high so that heat may flow to and from the sealing layer with minimal temperature difference.

Unfortunately, most liquids have thermal conductivities, below 0.5 W/mK which compares badly to most solid metals (stainless steel≅11 W/mK or Aluminium 235 W/mK).

A possible liquid with high thermal conductivity would be mercury as this has a thermal conductivity of 8 W/mK, however its toxicity is not compatible with use in this application. A preferred material is therefore one of the Cerro™ alloys as these materials have low melting points, typically in the range 40° C. to 100° C., which are below the working temperature of the platen. The Cerro™ alloys are alloys of bismuth, lead tin cadmium and indium with the ratios optimised for specific requirements.

An example of a preferred Cerro alloy is Cerrolow, as supplied by Hoyt Darachem which has a melting point of 47° C. and a thermal conductivity over ten times better than water.

One example of use of such an approach is shown in FIG. 6. In this example, the pressurising fluid 5″ fully occupies a closed volume behind the face plate 4″. When the face plate 4″ is not in contact with the surface to be sealed the fluid is at atmospheric pressure. However, when the face plate 4″ is pressed against the surface to be sealed, the face plate 4″ will be pushed against the fluid behind it. As the fluid is almost incompressible only a small movement is necessary for the fluid to be pressurised to balance the force acting to compress it.

In this way, the pressure in the fluid can be generated without the need for a pump.

Alternatively the fluid may be pressurised using an external pump such as the piston pump 11 in FIG. 1. This separates the control of the pressure of the fluid from the clamping force holding the plates against the package.

Alternative forms of pressurising the fluid could also be used including for example the use of compressed air to pressurise one side of a compliant or floppy diaphragm the other side of which is in contact with the fluid.

As only a small amount of movement is necessary to generate the pressure, the layer of fluid between the face plate and the back plate can be small, typically in the range 0.1 mm to 1.0 mm. Thus, heating and cooling of the back plate will be efficiently coupled via the fluid and face plate to the sealing surface.

Alternatively a fluid that will not be boiling at the operating temperature and pressure may be used as the pressurising fluid if it is preheated and then flowed over the back of the face plate 4. The flow of hot fluid introduces heat energy quickly and efficiently. The intimate contact of fluid to the thin stainless face plate 4 and its pressurised contact directly on to the lid provides excellent thermal transport of heat to the interface region at which the seal will be formed whilst minimising the thermal mass to be heated.

Once the interface has reached the desired temperature, the hot fluid flow is replaced by a cold fluid flow rapidly removing the heat from the package. Throughout the heating and cooling cycle uniform pressure can therefore be maintained over the surface to be sealed.

Typical sealing temperatures range between 75° C. and 150° C. Hot fluid temperatures in the range 100° C. to 250° C. would be suitable as would cold fluid temperature in the range 0° C. to 30° C.

In some cases it may be preferable to use water for both heating and cooling as in this instance if high temperature and low pressure conditions apply then during the heating phase the water would be part liquid and part vapour, i.e. steam, under some conditions the use of steam can be more efficient than pure liquid.

FIG. 3 shows a schematic cross section of such a sealing system. In this arrangement, the package to be sealed 21 is placed on the support plate 23 of the sealing press platen 28 so that the face to be sealed is rigidly supported over the whole of its area. The press platen 28 and the support plate 23 then move to bring the face plate 25 into contact with the upper surface of the lid 24 that is to be sealed to the package base 21. The face plate 25 has domed areas over the pockets 22 in the package to prevent any force being applied there. The fluid behind the face plate 25 is then pressurised by the pump 34 to press the face plate 26 against the package with the desired pressure. Meanwhile, the fluid in the reservoir 31 is maintained by the heater 32 at the temperature necessary to achieve sealing. The changeover valves 29a and 29b are set to link the platen fluid circuit to the hot reservoir and the circulating pump 30a is energised. This causes hot fluid to flow through the press 28, rapidly heating the area to be sealed. Meanwhile, the fluid in reservoir 33 is held at a controlled low temperature by the heat exchanger 35. When the seal has formed, determined for example either by time or by measurement of a relevant parameter such as the temperature of the face plate 25, the changeover valves 29a and 29b are activated to connect the platen fluid to the fluid in the cold reservoir 33. Circulating pump 30b is then powered to force the cold fluid into the press. Appropriate design of the thermal capacities, the fluid volume and its flow rate will enable very rapid heating and cooling of the area to be sealed. Once the sealed area is cool, then the flow can cease and the pump 34 can be stopped to remove the pressure. The package can then be removed with the seal fully formed. This approach produces a very fast cycle time as the whole of the area to be sealed is acted on simultaneously.

Preferably, an inlet is provided at the centre of the chamber and a plurality of outlets or a single annular outlet is provided at the periphery. This allows the temperature of the face plate and sealing interface to be changed rapidly and evenly. Of course the inlet/outlet arrangement can be reversed.

It is particularly advantageous where the package has high thermal mass and high thermal conductivity as, in this case cycle times on conventional equipment would be extremely slow, adversely effecting the economics of the operation.

It is clear that the switching of hot and cold fluids is not the only may of achieving the rapid heating and cooling of the platen press. Other examples of methods that could be employed include:
The use of electrical heaters directly heating the face plate or the platen press followed by using water or force air for cooling. This avoids the need for pumps capable of handling fluids at high temperatures
Non-contact heating the packaging around the area to be sealed directly. This includes the use of inductive heating of conducting materials or dielectric heating of insulators. This would enable the platen fluid circuit to be designed simply to provide pressure and cooling rather then heating as well.
Replacing the fluid with a high compliance solid material that has sufficient elasticity to evenly distribute the pressure may provide a simpler construction especially where coupled with direct electrical heating and indirect air or water cooling.

Where the heat seal bond maintains a substantial adherence even at its sealing temperature it is acceptable to use separate heating and cooling platen and for the package to be physically moved from the hot station to the cold station immediately after sealing.

Providing the movement time is short compared to the time taken for the sealing heat to reach the drug in the pockets then this provides a simple and effective approach.

Typically the transfer should be completed within 0.5 s to 5.0 s.

In this approach the hot platen can be maintained at a constant temperature continuously using, for example, resistive electrical heaters and a process temperature controller and the cold plates also maintained at a set temperature by the use of a water jacket with water circulating through a chiller before being fed to the platen.

The benefit of the invention may be further illustrated by reference to a particular design of packaging aimed to provide high integrity protection for multi unit dose packages of medicament to be used in a DPI. FIGS. 4(a) and (b) show an example of this type of package. The package has a body 41 that is substantially an annulus of a material of uniform thickness with outer and inner diameters 43 and 44. The body 41 has holes right through its thickness into which cup shaped receptacles 45 will fit. The holes 42 and cups 45 may be arranged in a regular circular array. Designs with any number of holes 42 or different arrangements of holes 42 may be used, one example being a disc of between 60 mm and 70 mm outer diameter that has 30 holes to contain 30 individual doses of medicament.

The side of the body, that has the closed ends of the cups, may be sealed by heat sealing a: lid 47 over the whole area of the body 41. The cups 45 may then be filled with medicament 46 and a lid 48 sealed over the other side of the body 41 to form the individually sealed unit doses. Preferably, both the body 41 and lids 47, 48 are made from a material that will protect the medicament from the outside environment. In particular, protection from water vapour is paramount for the DPI application. Thus, the material requires low water vapour transport rate (WVTR). Metals provide an almost perfect barrier to water vapour. Thus, one approach is to form the body 41 from aluminium and to use aluminium foil for the top and bottom lids 47, 48. Access to a unit dose of the medicament can then be made by rupturing or pealing the foil over an individual cup. Obviously other materials with acceptable barrier properties can be used.

The heat-sealing of aluminium foil to an aluminium body requires the use of an intermediate material that melts at an acceptable temperature. There are a range of materials used in the pharmaceutical industry for this purpose. Particularly suitable for joining aluminium to aluminium are the ethylene/methacrylic acid copolymers but other materials may also be suitable. The heat seal material may be applied to the lidding foil, the body or both and when heated to the appropriate temperature and pressed together completely fills the space between both metal components adhering well to both surfaces. However, such heat seal materials are not totally impermeable to water vapour which gives rise to a route by which water vapour might reach the medicament.

FIG. 5 shows an enlarged cross-section through the annulus from the edge of a cup to the outer diameter. The body 51 and the two aluminium foils 52 and 53 are completely impermeable to water vapour. The heat seal layers 54 and 55 however extend from the outside atmosphere 59 to the medicament 57. If the humidity of the air 59 is higher than that of the medicament 57 then water vapour 56 could diffuse through the heat seal layer and reach the medicament. In order to minimise this, the heat seal layer should be made as thin as possible and as long as acceptable within the overall package size.

However, the aluminium body 51 is a rigid member and, if the sealing pressure is also applied by a rigid plate or roller, then any height variation greater then the thickness of the heat seal layer will result in areas where there is much lower pressure and heat, possibly resulting in imperfect sealing. In addition, the thermal conductivity of aluminium is so high that any heat reaching the body 51 will diffuse throughout the body almost immediately. Thus the whole of the body 51 will be heated to the temperature at the interface between the heat seal layer 55 and the body 51.

Where the cup 58 is made of poorly thermally conductive material, the medicament will be protected from the body temperature for a short time. However if the body temperature remains high too long then the medicament will also be heated to this temperature.

Thus, to enable the very thin layers of heat seal material to be used to provide an excellent water vapour barrier and to avoid heating the medicament to an unacceptable temperature, the present invention allows the use of a compliant press pressing only on the areas to be sealed and the use of a means for introducing and removing heat from the package rapidly.

The process described previously provides one means of achieving this. It also conforms with the requirements of pharmaceutical manufacturing in terms of the materials that could potentially contact the medicament or packaging.

In the extreme, the thickness of the heat seal layer need only be sufficient to fill the surface roughness of the two aluminium surfaces. Thus, heat seal layers with thicknesses in the range 1 micron to 100 microns can be used. Previously, much thicker layers that flow under the pressure of sealing have been used to fill in the height variations implicit in the process.

The extremely high thermal conductivity of the thick aluminium body ensures that all parts of the sealing interface will approach the same temperature even with the high rate heating and cooling required for a fast cycle time. This is advantageous in assuring that a good bond is formed at all points on the surface.

The use of the thin stainless face plate enables a realistic specification for the flatness of the body of the package to be used. For example, with one manufacturing method, it has been observed that the height between holes can be up to 0.05 mm below the height at the edge of the holes. Allowing, for example, a distance of between 2.0 mm and 3.0 mm between the holes, then a rigid top plate would not apply any pressure between holes unless the heat seal layer was over 0.05 mm thick. However, 0.05 mm thick stainless face plate pressed on to the lidding foil by a pressurised fluid will exert pressure over the whole area whatever the thickness of the heat seal layer. This permits the use of heat seal layers of thickness in the range of 0.003 mm to 0.030 mm offering substantial benefits in water vapour barriers performance compared to thicker layers.

The high thermal conductivity of the aluminium body 51 ensures that heat is conducted rapidly across the thickness of the body. This is disadvantageous where the heat is being applied through the foil being sealed to the disc as it reduces the rate at which the sealing surface of the body reaches the desired sealing temperature. However it is beneficial in allowing any heat being applied through the opposite surface of the body to reach the sealing surface.

Thus to achieve the most rapid heating and cooling active platens as shown in the upper surface of FIG. 2 can be applied simultaneously to both sides of the disc almost halving the heating and cooling times

In this way it would be possible to seal either side of the body with foil on the same apparatus on even foil both sides simultaneously.

This is one example of a package design that benefits by this invention however the invention can be applied to any package design that benefits from the application of uniform pressure continuously throughout a rapid heating and cooling cycle.

1. An apparatus for heat sealing a lidding sheet to a base, the apparatus including:
a press for pressing a lidding sheet onto a sealing surface of a base; wherein
the press includes a relatively flexible face plate and the apparatus further includes a system for applying pressure to the lidding sheet with the face plate, the face plate flexing to conform to the lidding sheet and the underlying profile of the sealing surface of the base.

2. An apparatus according to claim 1 further including:
a support plate for supporting a back surface of the base opposite the sealing surface.

3. An apparatus according to claim 1 wherein the face plate comprises a flexible membrane with a first surface for pressing the lidding sheet, the system being arranged to selectively provide pressurised fluid to a second surface of the flexible membrane, the second surface being opposite said first surface.

4. An apparatus according to claim 3 wherein the fluid is pressurised in the range of 2 bar to 200 bar.

5. An apparatus according to claim 3 wherein the press further includes walls which define with the second surface a chamber for receiving the pressurised fluid.

6. An apparatus according to claim 3 wherein the pressurised fluid is at an elevated temperature suitable for achieving heat sealing.

7. An apparatus according to claim 3 wherein the fluid is a high conductivity fluid such as mercury or a bismuth alloy with low melting point.

8. An apparatus according to claim 5 wherein the chamber includes at least one inlet and at least one outlet such that fluid may be pumped in through the inlet and out through the outlet.

9. An apparatus according to claim 8 wherein the system is arranged to pump hot fluid in the inlet so as to heat the flexible membrane and lidding sheet for sealing and then to pump cold fluid in the inlet so as to force the hot fluid out through the outlet and thereby cool the flexible membrane and lidding sheet.

10. An apparatus according to claim 9 wherein the system provides hot fluid in the range of 100° C. to 250° C.

11. An apparatus according to claim 9 wherein the system provides cold fluid in the range of 0° C. to 30° C.

12. An apparatus according to claim 5 wherein the chamber is a fully filled closed volume in which the fluid is pressurised by pressing the first surface against the lidding sheet.

13. An apparatus according to claim 1 wherein the face plate is stainless steel.

14. An apparatus according to claim 1 wherein the face place has a thickness in the range of 0.01 mm to 0.5 mm.

15. An apparatus according to claim 13 wherein the face plate has a thickness in the range of 0.03 mm to 0.1 mm.

16. An apparatus according to claim 1 for heat sealing a lidding sheet to a base having at least one pocket wherein the face plate is reinforced in an area to be positioned opposite said at least one pocket so as to at least reduce deflection of the face plate into the pocket.

17. An apparatus according to claim 14 wherein the face plate is reinforced by pre-forming said area as a dome, recessed on the sealing side.

18. An apparatus according to claim 1 wherein the apparatus is arranged to compensate for angular misalignment of the face plate and the sealing surface of the base.

19. A method of heat sealing a lidding sheet to a base, the method including:
positioning a lidding sheet against the sealing surface of a base;
providing a relatively flexible face plate adjacent the lidding sheet; and
applying pressure to the lidding sheet with the face plate such that the face plate flexes to conform to the lidding sheet and the underlying profile of the sealing surface of the base.

20. A method according to claim 19 using a flexible membrane as the face plate and further including providing pressurised fluid behind the flexible membrane to flex the flexible membrane and apply pressure to the lidding sheet.

21. A method according to claim 20 further including:
rapidly exchanging the pressurised fluid from hot fluid to cold fluid so as to rapidly heat and then cool the face plate whilst maintaining pressure to the lidding sheet.

22. A method according to claim 21 wherein preheated hot fluid is flowed behind the flexible membrane whilst maintaining the pressure of this fluid at the sealing pressure and then the flow is switched to a pre-cooled fluid at the same pressure for cooling of the lidding sheet and seal.

23. A method according to claim 19 further including:
rapidly heating and then cooling the face plate whilst maintaining pressure to the lidding sheet.

24. A method according to claim 19 using a flexible membrane as the face plate and further including providing fluid behind the flexible membrane and pressurizing the fluid by pressing the flexible membrane against the lidding sheet.

25. A method according to claim 19 wherein the fluid is a high conductivity fluid, such as mercury or bismuth alloy of low melting point, for rapidly cooling the face plate and lidding sheet.

26. A method of heat sealing a lidding sheet to a base, the method including:
positioning a lidding sheet against the sealing surface of a base;
providing a face plate adjacent the lidding sheet; and
applying pressure to the lidding sheet with the face plate whilst heating and cooling the lidding sheet so as to heat seal the lidding sheet to the base.
